(19) United States
(12) Patent Application Publication
(10) Pub. No.: US 2020/0079630 A1
(43) Pub. Date: Mar. 12, 2020

(54) DRIVERLESS TRANSPORTER

(71) Applicant: Liebherr-Verzahntechnik GmbH, Kempten (DE)

(72) Inventor: Thomas MATTERN, Rieden (DE)

(21) Appl. No.: 16/563,765

(22) Filed: Sep. 6, 2019

(30) Foreign Application Priority Data
Sep. 6, 2018 (DE) 10 2018 121 743.9

(51) Int. Cl. B66F 9/06; G05D 1/02; B66F 9/12; B66F 9/14; B66F 9/18

(52) U.S. Cl. CPC B66F 9/063; G05D 1/0225; G05D 2201/0216; B66F 9/14; B66F 9/18; B66F 9/122

(57) ABSTRACT

The present application discloses a driverless transporter, which comprises an undercarriage, a drive and a control unit, for transporting goods, such as for loading a transfer station with one or a plurality of workpieces. The driverless transporter comprises here a handling arrangement with a telescopic extension for moving the transported goods in a horizontal direction.

### CROSS REFERENCE TO RELATED APPLICATIONS

The present application claims priority to German Application No. DE 10 2018 121 743.9 entitled “DRIVERLESS TRANSPORTER”, filed on Sep. 6, 2018. The entire contents of the above listed application are hereby incorporated by reference for all purposes.

### TECHNICAL FIELD

The present application relates to a driverless transporter, which comprises an undercarriage, a drive and a control unit, for transporting goods.

### BACKGROUND AND SUMMARY

Driverless transport systems comprising a plurality of driverless transporters are increasingly used for automating transport processes, e.g. within logistics centers.

Furthermore, there are first attempts to use driverless transport systems within production plants in order to transport workpieces between individual production stations.

However, no satisfactory solution has yet been found as to how such driverless transport systems can be used for directly loading a transfer station, e.g. in the form of a machine tool and/or a storage facility, by means of a driverless transporter, i.e. without intermediate use of a stationary handling arrangement, such as a robot.

Such as, attempts to use forklift trucks as driverless transporters and to transfer workpieces placed on the fork to a transfer station entail the problem that the relative movement required for transfer must be generated via the undercarriage of the forklift truck.

Therefore, it is the object of the present application to provide an improved driverless transporter and a corresponding driverless transport system.

An embodiment of the present application comprises a driverless transporter, which comprises an undercarriage, a drive and a control unit, for transporting goods, such as for loading a transfer station with one or a plurality of workpieces. According to the present application, the driverless transporter comprises a handling arrangement with a telescopic extension for moving the transported goods in a horizontal direction. The handling arrangement with the telescopic extension allows simpler transfer of the transported goods from the transporter to a transfer station and/or simpler taking over of the transported goods from a transfer station to the transporter. Such as, the handling arrangement with the telescopic extension allows transported goods to be transferred and/or taken over, without any necessity of operating the undercarriage, i.e. the transfer and/or the taking over can, in the stationary condition of the transporter, be effected via axes of movement of the handling arrangement alone.

The driverless transporter may be used for transporting workpieces and/or pallets for workpieces in a production plant.

According to an embodiment of the present application, the handling arrangement additionally comprises a lifting device for moving the transported goods in a vertical direction.

The lifting device may be arranged such that the telescopic extension is lifted by the lifting device. To this end, the lifting device may be mounted on the undercarriage and may, in turn, carry the telescopic extension.

By way of example, the lifting device may be configured as a lifting platform having the telescopic extension mounted thereon.

According to a possible embodiment of the present application, the telescopic extension is arranged on the driverless transporter such that, when seen in a top view, the transported goods are arranged, in the retracted condition of the telescopic extension, within the transporter base area defined by the undercarriage and/or a chassis of the transporter and can be moved to a position laterally next to the base area by pulling out the telescopic extension.

An embodiment of the telescopic extension provides, at its retracted position, a transfer position for the transported goods, at which the transported goods are arranged, when seen in a top view, within the transporter base area defined by the undercarriage and/or a chassis of the transporter. This will help to prevent the transporter from tipping over during transport, even without the use of counterweights. Counterweight are often used in the case of forklift trucks. In addition, the risk of injury and/or collision during transport is reduced.

The transported goods may remain on the telescopic extension while they are being transported. Alternatively or additionally, the transporter may, however, also have a deposit place for the transported goods.

An embodiment of the telescopic extension is, when occupying the retracted position, located completely above and/or within a housing of the transporter and therefore does not form an interfering edge during transport.

Pulling out the telescopic extension allows the transported goods to be moved from the area of the transporter laterally to a transfer position, at which they are located in the area of a transfer station.

According to a possible embodiment of the present application, the telescopic extension has arranged thereon a handling element for gripping and/or picking up the transported goods. The handling element may be arranged on a telescoping rail element of the telescopic extension. The handling element is e.g. a gripper and/or a fork.

According to a possible embodiment, the telescopic extension may be provided with two telescopic rails having the handling element arranged thereon.

According to a possible embodiment of the present application, the handling arrangement comprises at least one further axis of movement for moving the transported goods in a horizontal plane.

An embodiment of the further axis of movement is a vertical axis of rotation and/or a transverse shuttle.

The further axis of movement may be arranged such that it moves the telescopic extension. An embodiment of the further axis of movement allows a movement transversely to the pull-out direction of the telescopic extension.

An embodiment of the further axis of movement is arranged between the lifting device and the telescopic extension.

According to a possible embodiment of the present application, the handling arrangement comprises at least two telescopic extensions. The use of two telescopic extensions allows a processed workpiece to be replaced by a not yet processed workpiece by means of one transporter. Some embodiments may use only one transporter.

According to a possible embodiment of the present application, the telescopic extensions have parallel pull-out directions.

Depending on the respective embodiment, the two extensions may be arranged side by side, one above the other or in alignment with each other.

According to a possible embodiment of the present application, the transporter comprises at least one and possibly at least two places for depositing transported goods.

An embodiment of the axes of movement of the handling arrangement are configured such that transported goods can be deposited on and/or picked up from a deposit place by means of the telescopic extension. The deposit place or places may be used for the transport of the transported goods or as a temporary deposit place during the process of loading a transfer station.

According to a possible embodiment of the present application, the telescopic extension is pivotable via a vertical axis of rotation towards the deposit place and/or the deposit places. The vertical axis of rotation may e.g. be used for pivoting the telescopic extension back and forth between two deposit places.

According to a possible embodiment of the present application, the driverless transporter comprises a coupling unit for mechanically coupling the transporter to a transfer station. Such a coupling arrangement can be used, since the transported goods can be transferred without displacing the transporter.

According to a possible embodiment of the present application, the coupling unit serves to center and/or support the transporter. An embodiment of the coupling unit defines a fixed position of the transporter relative to the transfer station and/or prevents the transporter from tipping over, when, by pulling out the telescopic extension, the transported goods are moved out of the base area, which is defined by the undercarriage and/or a chassis of the transporter.

An embodiment of the coupling unit may comprise guide areas through which the transporter is guided to a defined position during a displacement motion.

Alternatively or additionally, the coupling arrangement can allow a form-fit connection in at least one direction.

According to a possible embodiment of the present application, a sensor is provided for detecting that coupling has taken place.

According to a possible embodiment of the present application, the control unit is configured such that transported goods cannot be moved by the telescopic extension to a location outside the base area of the transporter until coupling has taken place.

Alternatively or additionally, the telescopic extension cannot be pull d out until coupling has taken place.

Both said measures significantly increase the operational safety, since tipping over of the transporter and/or collisions with the telescopic extension and/or the transported goods during transport will be avoided.

The drive of the transporter may such as be a propelling drive which, together with the undercarriage, allows the transporter to be moved. The propelling drive may be controlled by the control unit.

The telescopic extension may comprises a drive, which is controlled by the control unit and through which the telescopic extension is moved. The drive provided may e.g. be a motor cooperating with a belt drive comprising a driver. Alternatively, other linear drives may be used, e.g. in the form of a cylinder and/or an electromechanical linear drive.

An embodiment of also the lifting device and/or the other axes of movement are provided with drives, which are controlled by the control unit.

The control unit may communicate with and be controlled by a higher-level transport control system and/or receive orders and/or commands therefrom.

The present application also includes a driverless transport system comprising at least one driverless transporter of the type described in detail herein before as well as at least one transfer station.

According to a possible embodiment of the present application, the driverless transporter and the transfer station are configured such that goods transported by the transporter can be moved by means of the telescopic extension from a transport position in the area of the transporter to a transfer position in the area of the transfer station and/or transported goods can be moved by means of the telescopic extension from a transfer position in the area of the transfer station to a transport position in the area of the transporter.

Such as, the transporter may here be moved to a loading position next to the transfer station and the transported goods may be transferred to and/or taken over from the transfer station by means of the telescopic extension.

In so doing, the transported goods may such as be moved across elements of the transfer station to the transfer position by means of the telescopic extension.

According to a possible embodiment of the present application, the transfer station is a machine tool. The driverless transporter can thus be used for loading the machine tool with workpieces.

According to a possible embodiment of the present application, the system is configured such that, making use of the driverless transporter, the workpiece is transferred directly to a processing position and/or taken over directly from a processing position, e.g. directly transferred to a workpiece holder and/or taken over directly from a workpiece holder, in which the workpiece is also processed. In this way, the machine tool need not comprise a transfer position, which is separate from the processing position and which takes over the workpiece and from which the workpiece is moved to a processing position.

According to a possible embodiment of the present application, the system is configured such that, making use of the driverless transporter, the workpiece is transferred to a transfer position of the machine tool and/or taken over from such a transfer position, the workpiece being moved by an automation of the machine tool from the transfer position to a processing position and vice versa.

According to a possible embodiment of the present application, the transfer station is a material lock. For example, the material lock may allow the transfer of transported goods, e.g. workpieces, into an area surrounded by a safety fence and/or the taking over of transported goods, e.g. workpieces, from such an area.

According to a possible embodiment of the present application, the transfer station is a storage facility and/or a storage rack. The transfer and/or takeover may also here take place directly into storage spaces and/or shelf spaces and/or to a transfer position from where the transported goods are moved into storage spaces and/or shelf spaces by an automation of the storage facility and/or the storage rack.

According to a possible embodiment of the present application, the transfer station comprises a coupling arrangement for mechanically coupling the transporter.

The coupling arrangement may be used for centering and/or supporting the transporter. According to an embodiment, the coupling arrangement is configured such that it will prevent tilting of the transporter during pulling out of the telescopic extension.

According to a possible embodiment of the present application, the transporter may be controlled such that, in a first step, it moves to a loading position by means of the undercarriage and, in a second step, it transfers, without the undercarriage being operated, the transported goods to the transfer station, such as through axes of movement of the handling arrangement, such as by actuating the telescopic extension and/or the lifting device.

According to a possible embodiment of the present application, inaccuracies in the process of reaching the loading position are compensated for by at least one further axis of movement of the transporter, such as by means of a transverse shuttle and/or a vertical axis of rotation.

The transporter may be controlled automatically. The control may be effected via the control of the transporter and/or by a higher-level transport control system.

According to a possible embodiment, the driverless transport system comprises a plurality of driverless transporters.

According to a possible embodiment, the driverless transport system comprises a plurality of transfer stations, such as a plurality of transfer stations of the type described hereinbefore. An embodiment of a storage facility and/or a storage rack and/or one or a plurality of machine tools may be connected to one another by the driverless transport system.

The present application additionally comprises a method of operating a driverless transport system comprising at least one driverless transporter and at least one transfer station, of the type described hereinbefore, the method comprising the following steps:

moving a driverless transporter to a loading position, at which the transporter is arranged next to a transfer station,

actuating the telescopic extension for loading the transfer station with transported goods and/or for removing transported goods from the transfer station.

According to a possible embodiment of the present application, the transporter removes a processed workpiece from the transfer station in a first step and transfers a non-processed work-piece thereto in a second step. An embodiment including no movement of the transporter via its undercarriage takes place between the two steps and/or the transporter remains fixedly at its loading position.

According to a possible embodiment of the present application, the transporter is mechanically coupled to the transfer station at the loading position.

An embodiment of the driverless transport system is configured such that the method according to the present application is carried out automatically.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The present application will now be explained in more detail making reference to drawings and embodiments.

### BRIEF DESCRIPTION OF THE DRAWINGS

FIG. 1 shows a first embodiment of a driverless transport system in a perspective representation,

FIG. 2A/B/C show the first embodiment in a first side view, a second side view, and a top view,

FIG. 3 shows a second embodiment of a driverless transport system in a perspective representation,

FIG. 4A/B/C show the second embodiment in a first side view, a second side view, and a top view,

FIG. 5 shows a third embodiment of a driverless transport system in a perspective representation,

FIG. 6A/B/C show the third embodiment in a first side view, a second side view, and a top view,

FIG. 7 shows the removal of a workpiece from a transfer station by a driverless transporter according to the present application,

FIG. 8 shows a first embodiment of a system comprising a driverless transporter and a transfer station, the transfer station being configured as a machine tool, and

FIG. 9 shows a second embodiment of a system comprising a driverless transporter and a transfer station, the transfer station being configured as a material lock.

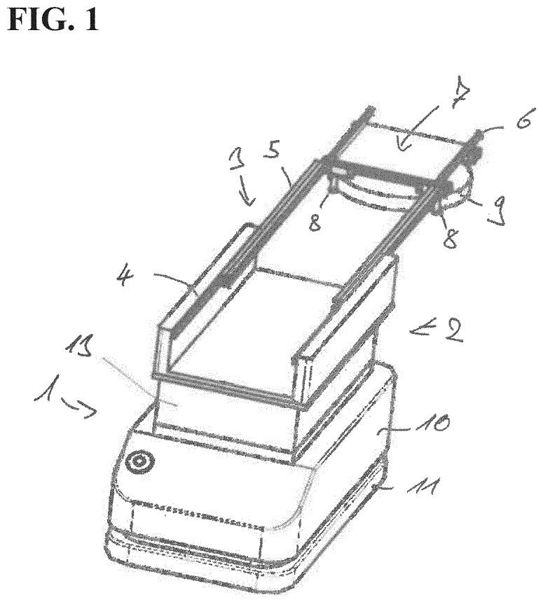

FIGS. 1-9 are shown approximately to scale.

### DETAILED DESCRIPTION OF THE DRAWINGS

FIGS. 1 to 6 show three embodiments of a driverless transporter according to the present application having the basic structural design described hereinafter:

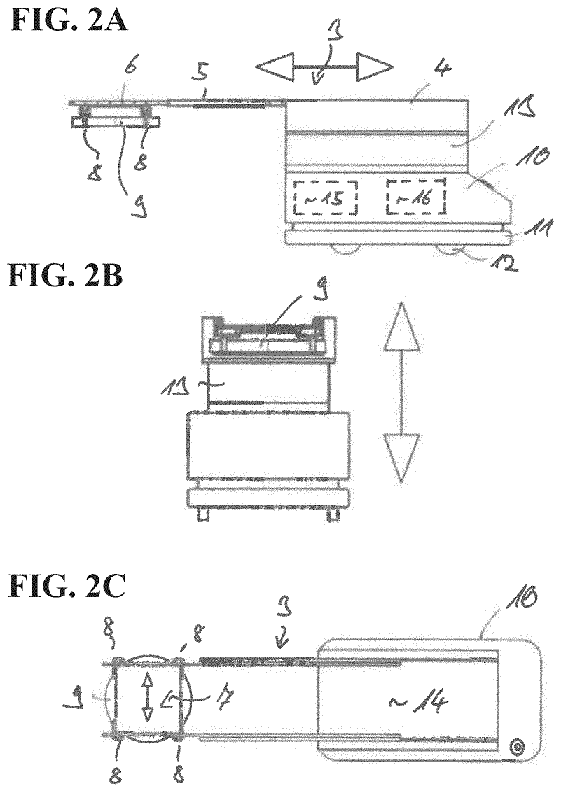

The transporters comprise an undercarriage 12 with which they can be moved. In the embodiment, the undercarriage 12 has four wheels, at least two being steerable. In some embodiments, all four wheels may be steerable. The undercarriage is driven by a transporter drive 15 shown in FIG. 2.

The drive may be electric. The transporter may comprise an energy store, such as an electric energy store, a battery and/or supercaps, which provides the energy for the drive.

The transporter also comprises a control unit 16 which controls the drive, the steering system and the axes of movement of the transporter. The transporter may drive autonomously and/or semi-autonomously and/or it may be controlled by a transport guidance system. The control unit 16 includes a processor and memory which stores instructions for at least controlling the transporter. The control unit 16 may also include instructions for preventing transported goods from being moved by the telescopic extension to a location outside the base area of the transporter until coupling has taken place and/or the telescopic extension cannot be pulled out until coupling has taken place.

The transporter 1 comprises a handling arrangement 2 with a telescopic extension 3 for moving transported goods 9 in a horizontal direction. The telescopic extension comprises at least one telescopic element 5, 6 mounted on a support rail 4 so as to be longitudinally displaceable thereon. In the present embodiment, two telescopic rails are provided, each with at least one telescopic element 5, 6 mounted on a support rail 4 in a longitudinally displaceable manner. The telescopic elements 6 have a handling element 7 provided thereon, at which the transported goods, such as a workpiece, can be supported.

In the first embodiment, two telescopic elements 5 and 6 are provided, which are supported such that they are longitudinally displaceable on each other, in the second and third embodiments one telescopic element 6 may be provided.

The handling arrangement 2 further comprises a lifting device 13, through which the telescopic extension 3 is vertically displaceable. In the present embodiment, the lifting device 13 is configured as a lifting platform having the telescopic extension 3 arranged thereon.

The transporter according to the present embodiment comprises a chassis 10, which has a circumferential bumper 11 in the present embodiment. The handling arrangement 2 and such as the lifting device are arranged on the upper side of the chassis 10.

The telescopic extension is arranged on the transporter in such a way that, at the retracted position of the telescopic extension, an item of transported goods supported at the handling element of the telescopic extension is located within a base area 14 of the transporter, the base area being defined by the undercarriage and/or the chassis. Safe transport of the transported goods is accomplished in this way and the risk of tipping over is reduced.

In the present embodiment, the support rails 4 are arranged on an Inner side of an outer boundary, such as a wall element, so that, at the retracted position, the telescopic elements 5, 6 are located between the outer boundaries and, such as, between the wall elements. An embodiment of the transported goods are also supported at the handling element such that, at the retracted position of the telescopic extension, they are located between the outer boundaries and, such as, between the wall elements.

The telescopic extension or extensions may have a base area, which occupies at least 10% of the base area of the transporter, further at least 25% and 50% of the base area of the transporter. The base area of a telescopic extension is defined by its width multiplied by its length at the retracted position.

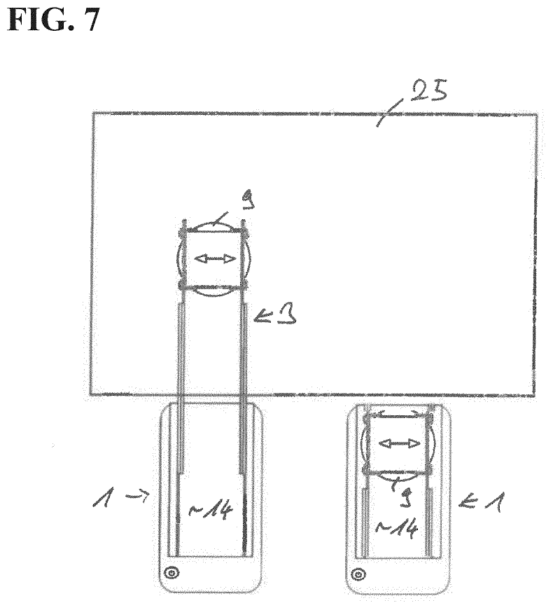

The telescopic extension is arranged and configured such that transported goods, such as a workpiece, supported at the handling element can be moved to a position next to the base of the transporter. As shown schematically in FIG. 7, the transported goods can thus be moved into the area of a transfer station, when the transporter is arranged next to this transfer station, so as to transfer the transported goods there, and/or the handling element can be moved into the area of a transfer station, when the transporter is arranged next to this transfer station, so as to take over the transported goods there.

Such as, the telescopic extension allows the transported goods to be taken over or transferred without the necessity of moving the transporter.

In the case of the embodiment shown in FIGS. 1 and 2, one telescopic extension 3 m provided. The latter extends along the longer side of the undercarriage of the transporter. A very large reach of the telescopic extension can be accomplished in this way.

The handling element 7 provided is here a gripper. In the present embodiment, it is a mechanical gripper with movable gripper jaws 8, by means of which a workpiece 9 can be gripped.

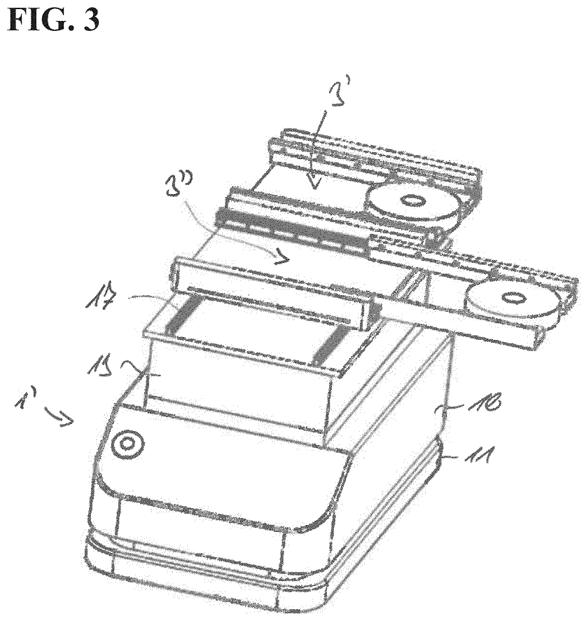

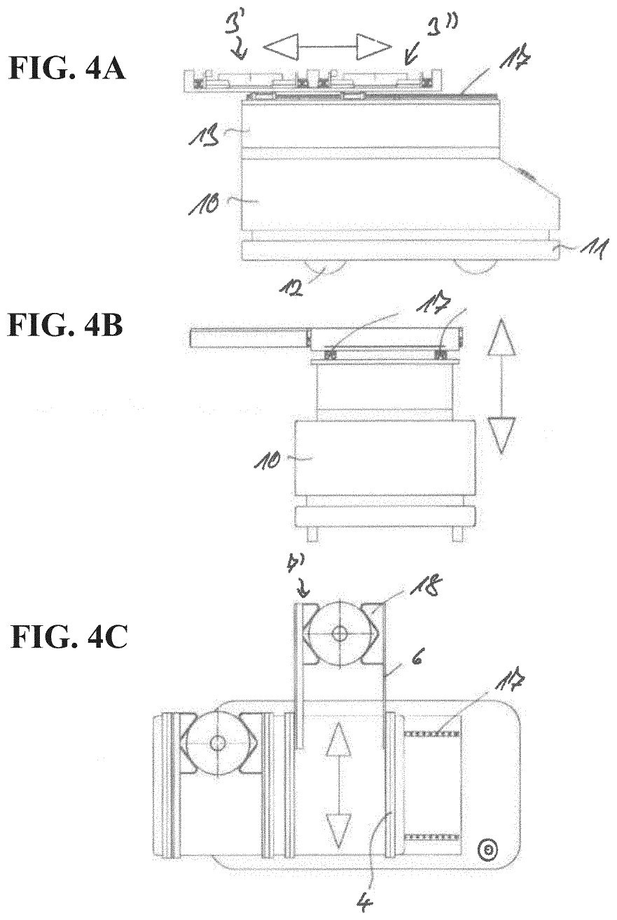

In the case of the second embodiment shown in FIGS. 3 and 4, two telescopic extensions 3′ and 3″ are provided. They allow taking over of a finished workpiece and transfer of a workpiece to be processed.

The telescopic extensions 3′ and 3″ are arranged parallel to each other. In the present embodiment, they are placed side by side. They extend along a shorter side of the transporter.

According to an alternative structural design, the two telescopic extensions 3′ and 3″ may also be placed one above the other. In this case, the telescopic extensions 3′ and 3″ may also extend along the longer side of the transporter, as is known for the telescopic extension 3 according to the first embodiment

According to a further alternative structural design, the two telescopic extensions 3′ and 3″ may also be aligned with each other and therefore extendable in opposite directions.

In the embodiments shown in FIGS. 2 to 6, the handling arrangement has a further axis of movement 17, 19 through which the telescopic extension can be moved in a horizontal plane. The further axis of movement is here arranged such that a two-dimensional operating space for the handling-element is defined by the further axis of movement and the telescopic extension. If a lifting device is additionally provided, a three-dimensional operating space is obtained.

In the case of the second embodiment shown in FIGS. 2 to 4, the further axis of movement is configured as a transverse shuttle. To this end, the telescopic extensions 3 are arranged on a carriage that it is movable along a guide in a direction which is perpendicular to the pull-out direction of the telescopic extensions.

The transverse shuttle allows to alternately move the first and second telescopic extensions 3′ and 3″ to the same position, without moving the transporter. In this way, a first workpiece can be taken over from the transfer position by means of one telescopic extension and a second workpiece can be moved to the same transfer position by means of the second telescopic extension, these steps taking place in succession.

In the middle position of the transverse shuttle, however, both telescopic extensions and/or the workpieces supported thereat are located within the base area 14 of the transporter.

In the case of the embodiment shown In FIGS. 3 and 4, the handling element 3′ is again configured as a gripper, which, however, does not grip around the workpiece but clamps it laterally.

A transverse shuttle, as shown in FIGS. 3 and 4, may also be used in the embodiment shown in FIGS. 1 and 2 with one telescopic extension 3, and in the case of this structural design such as for the fine positioning of the workpiece and/or the compensation of errors in the positioning of the transporter relative to the transfer station. Some embodiments may use only one telescopic extension.

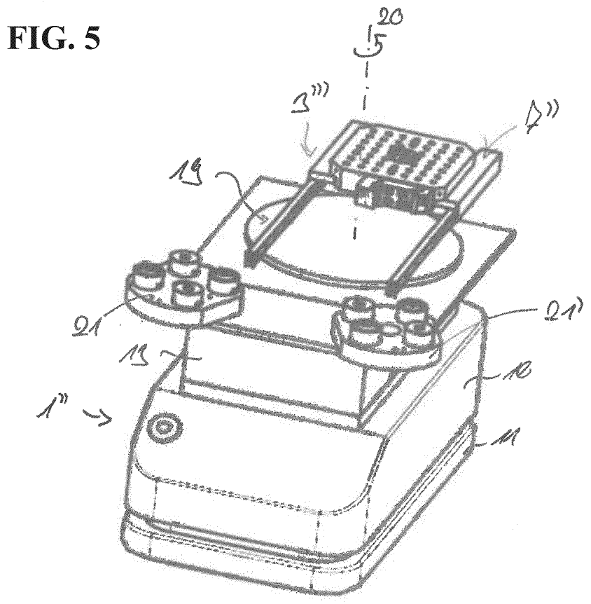

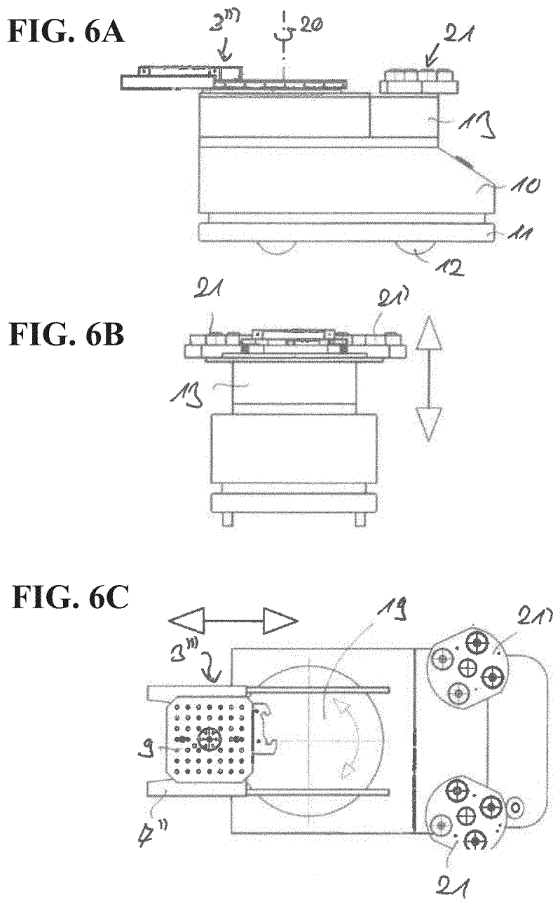

According to the third embodiment shown in FIGS. 5 and 6, a rotary table 19 is provided as a further axis of movement, on which the telescopic extension is arranged and via which the latter can be pivoted about a vertical axis of rotation 20.

According to the third embodiment shown in FIGS. 5 and 6, two deposit places 21 and 21′ for depositing transported goods, such as workpieces, are additionally provided. The deposit places and the telescopic extension are configured such that, by means of the telescopic extension and the further axis of movement, transported goods and such as workpieces, which have been picked up by the handling element of the telescopic extension, can optionally be deposited on one of the two deposit places and/or picked up therefrom by means of the handling element.

The third embodiment allows, by means of one telescopic extension, taking over of a first workpiece from a transfer position, depositing it on one of the two workpiece deposit places and picking up a second workpiece from the other workpiece deposit place and moving this workpiece to the transfer position; For the actual transport, however, the respective workpiece may be supported at the handling element and is therefore located within the base area. For reasons of space, the workpiece deposit places are, however, arranged at the edge of the base area.

According to the embodiment shown in FIGS. 5 and 6, the rotary table is arranged such that, by rotating the rotary table, the telescopic extension can be directed optionally to the first and the second workpiece deposit place.

The rotary table 19 is arranged on one side of the base area and the two workpiece deposit places are arranged on the opposite side of the base area, the longer sides of the base area extending from the rotary table to the workpiece deposit places.

Transfer of the workpieces to the transfer station takes place at a third rotary position of the rotary table, at which the telescopic extension is oriented parallel to the longer sides of the base area.

A rotary table of the type shown in FIGS. 5 and 6 may, however, also be used independently of the use of workpiece deposit places. For example, such a rotary table may have arranged thereon an arrangement of two telescopic extensions, which are adapted to be extended in opposite directions.

Likewise, it is imaginable to use a telescopic extension comprising a plurality of handling elements which are arranged thereon.

According to the embodiment shown in FIGS. 5 and 6, a fork is provided as a handling element 7″, which can be used for supporting thereon a pallet on which one or a plurality of workpieces can be clamped in position.

It goes without saying that the handling elements described in connection with the individual embodiments can also be used in combination with the respective other embodiments.

FIG. 7 shows the transfer 9f a workpiece from the transporter 1 to a transfer station 25. On the right-hand side, the transporter with the workpiece 9 is shown at a transport position, at which the telescopic extension is retracted and the workpiece held on the handling element is located within the base area 14. On the left-hand side, however, the telescopic extension is shown at a position, at which the workpiece has been moved to a transfer position in the area of the transfer station by pulling out the telescopic extension 3.

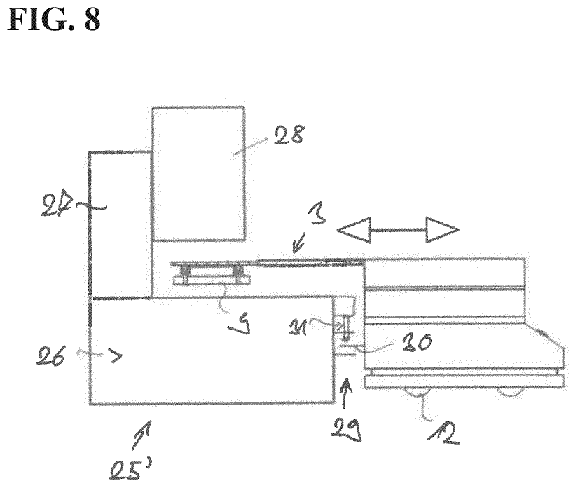

FIG. 8 shows schematically a case of use in which the transfer station 25′ is a machine tool, e.g. a gear cutting machine. The latter comprises a machine table 25 with a workpiece holder and a machine stand 27 with a processing head for processing a workpiece accommodated in the workpiece holder. The telescopic extension 3 now allows moving a workpiece across the machine table to the workpiece holder and/or picking up a workpiece from the workpiece holder and moving it to the transporter. In the present embodiment, the machine tool additionally comprises a counterstand 28, the workpiece being adapted to be moved in between the workpiece holder and the counterstand by means of the telescopic extension in order to be clamped there.

Alternatively, the workpieces could, however, also be taken over from and transferred to a transfer arrangement, which is provided separately from the workpiece holder. In this case, an automation of the machine tool may be provided for transporting workpieces from the workpiece holder to the transfer arrangement and back.

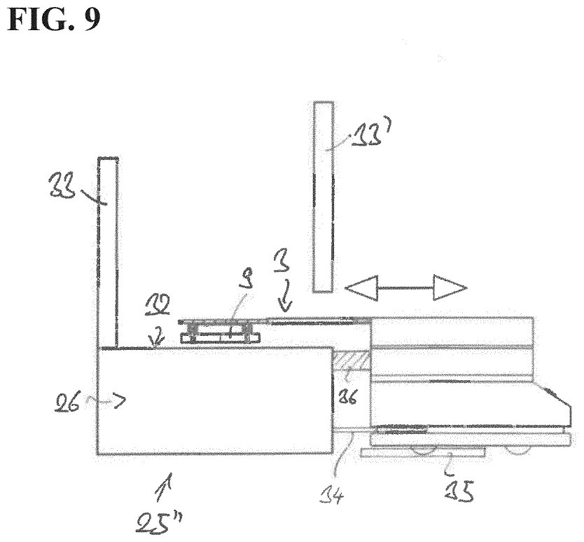

FIG. 9, however, shows a case of use, in which the telescopic extension is used for moving a workpiece 9 into the area of a material lock 25″ and for picking it up from there. The material lock has a first and a second lock wall 33 and 33′, which separate the interior of the lock from an area within a safety fence and an area outside a safety fence. The transporter may here be positioned in an area outside the safety fence next to the material lock and can move workpieces into and/or out of the material lock by actuating the telescopic extension. For this purpose, a lock wall 33′ is opened to such an extent that the telescopic extension can be moved into the interior of the material lock.

For transferring and/or taking over goods and such as workpieces, the transporter may be moved by means of the undercarriage to a defined loading position next to the transfer position. The transfer and/or take-over is/are may then be executed, in a stationary condition of the transporter, via the movement axes of the handling arrangement alone.

At the loading position, the transporter can be coupled mechanically to the transfer station. On the one hand, this can serve to support the transporter and to secure it against tipping over during pulling out of the telescopic extension. On the other hand, the transporter can be guided and/or centered so that it will be guided into the loading position.

FIG. 8 shows a variant in which mechanical coupling takes place in a form-fit manner by means of a coupling arrangement 29. To this end, the transporter comprises a lug and the transfer station a bolt 31, which may be movable by a drive and which couples with the lug. The coupling arrangement 29 may also include a sensor to detect successful coupling.

The coupling arrangement serves to center and/or support the transporter. An embodiment of the coupling unit defines a fixed position of the transporter relative to the transfer station and/or prevents the transporter from tipping over, when, by pulling out the telescopic extension, the transported goods are moved out of the base area, which is defined by the undercarriage and/or a chassis of the transporter.

An embodiment of the coupling arrangement may comprise guide areas through which the transporter is guided to a defined position during a displacement motion.

In FIG. 9 a fork 34 is provided, which grips around the transporter and/or engages guides arranged on both sides of the transporter. Alternatively or additionally, a guide rail 35 is provided for the wheels of the undercarriage, or a roller guide through which the transporter is guided into the loading position on both sides thereof. Furthermore, a rail, which couples with the transporter, may be provided on the floor, alternatively or additionally.

In addition, a stop 36 with a support surface is provided at the transfer station, by means of which the transporter rests on the transfer station at a loading position and which prevents the transporter from tipping over.

Coupling to the transfer station may, of course, also take place indirectly, for example by coupling the transporter with a coupling element which, like the transfer station, is fixedly connected to the floor.

FIGS. 1-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the value or range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A driverless transporter for transporting goods, comprising:
an undercarriage,
a drive,
a control unit, and
a handling arrangement with a telescopic extension for moving the transported goods in a horizontal direction.

2. The driverless transporter according to claim 1, wherein the driverless transporter further comprises a lifting device for moving the transported goods in a vertical direction, the telescopic extension being lifted by the lifting device, and the lifting device being configured as a lifting platform having the telescopic extension mounted thereon.

3. The driverless transporter according to claim 1, wherein the telescopic extension is arranged on the driverless transporter such that, when seen in a top view, the transported goods are arranged within the transporter base area defined by the undercarriage when the telescopic extension is in a retracted condition, and/or
a chassis of the transporter and can be moved to a position laterally next to the base area by pulling out the telescopic extension.

4. The driverless transporter according to claim 1, wherein the telescopic extension has arranged thereon a handling element for gripping and/or picking up the transported goods.

5. The driverless transporter according to claim 1, wherein the handling arrangement comprises at least one further axis of movement for moving the transported goods in a horizontal plane.

6. The driverless transporter according to claim 1, wherein the handling arrangement comprises at least two telescopic extensions.

7. The driverless transporter according to claim 1, comprising at least one place for depositing transported goods.

8. The driverless transporter according to claim 1, further comprising a coupling arrangement for mechanically coupling the transporter to a transfer station, wherein the coupling arrangement serves to center and/or support the transporter, wherein a sensor is provided for detecting that coupling has taken place and/or the control unit is configured such that transported goods cannot be moved by the telescopic extension to a location outside the base area of the transporter until coupling has taken place and/or the telescopic extension cannot be pulled out until coupling has taken place.

9. A driverless transport system comprising:
at least one driverless transporter for transporting goods, comprising:
an undercarriage,
a drive,
a control unit, and
a handling arrangement with a telescopic extension for moving the transported goods in a horizontal direction; and
at least one transfer station,
wherein the driverless transporter and the transfer station are configured such that goods transported by the transporter can be moved by means of the telescopic extension from a transport position in the area of the transporter to a transfer position in the area of the transfer station and/or
transported goods can be moved by means of the telescopic extension from a transfer position in the area of the transfer station to a transport position in the area of the transporter.

10. The driverless transport system according to claim 9, wherein the transfer station is at least one of: machine tool, a material lock, a storage facility, and a storage rack.

11. The driverless transport system according to claim 9, wherein the transfer station comprises a coupling arrangement for mechanically coupling the transporter, the coupling arrangement being used for centering and/or supporting the transporter and preventing a tilting of the transporter during pulling out of the telescopic extension.

12. The driverless transport system according to claim 1, wherein the transporter includes a processor and memory storing instructions for:
in a first step, moving to a loading position by means of the undercarriage,
in a second step, transferring without the undercarriage being operated, the transported goods to the transfer station by actuating the telescopic extension and/or the lifting device, and
compensating for inaccuracies in the process of reaching the loading position by at least one further axis of movement of the transporter.

13. A method of operating a driverless transport system comprising at least one driverless transporter comprising:
moving a driverless transporter to a loading position, at which the transporter is arranged next to a transfer station, wherein the driverless transporter comprises: an undercarriage, a drive, a control unit, and a handling arrangement with a telescopic extension for moving the transported goods in a horizontal direction
actuating the telescopic extension for loading the transfer station with transported goods and/or for removing transported goods from the transfer station.

14. The method according to claim 13, further comprising removing a processed workpiece from the transfer station in a first step, and
transferring a non-processed workpiece thereto in a second step,
wherein, no movement of the transporter via its undercarriage takes place between the two steps and/or the transporter remains fixedly at its loading position.

15. The method according to claim 13, wherein the transporter is mechanically coupled to the transfer station at the loading position.

16. The driverless transporter of claim 1, wherein the driverless transporter is for loading a transfer station with one or a plurality of workpieces.

17. The driverless transporter according to claim 4, wherein the handling element is a gripper and/or a fork.

18. The driverless transporter according to claim 5, wherein the at least one further axis of is a vertical axis of rotation and/or a transverse shuttle, and the further axis of movement moving the telescopic extension and/or being arranged between the lifting device and the telescopic extension.

19. The driverless transporter according to claim 6, wherein the telescopic extensions having parallel pull-out directions and/or being arranged side by side, one above the other or in alignment with each other.

20. The driverless transporter according to claim 7, comprising at least two places for depositing transported goods, wherein the axes of movement of the handling arrangement are configured such that transported goods can be deposited on and/or picked up from a deposit place by means of the telescopic extension, the telescopic extension being pivotable via a vertical axis of rotation towards the deposit place and/or the deposit places.
